(19) United States
(12) Patent Application Publication
(10) Pub. No.: US 2009/0310333 A1
(43) Pub. Date: Dec. 17, 2009

(54) ELECTRON EMISSION DEVICE, ELECTRON EMISSION TYPE BACKLIGHT UNIT INCLUDING THE SAME, AND METHOD OF MANUFACTURING THE ELECTRON EMISSION DEVICE

(76) Inventors: So-Ra Lee, Suwon-si (KR); Jae-Myung Kim, Suwon-si (KR); Yoon-Jin Kim, Suwon-si (KR); Hee-Sung Moon, Suwon-si (KR); Kyu-Nam Joo, Suwon-si (KR); Hyun-Ki Park, Suwon-si (KR); Young-Suk Cho, Suwon-si (KR)

Correspondence Address: CHRISTIE, PARKER & HALE, LLP, PO BOX 7068, PASADENA, CA, 91109-7068, US

(21) Appl. No.: 12/362,949

(22) Filed: Jan. 30, 2009

(30) Foreign Application Priority Data
Jun. 17, 2008 (KR) 10-2008-0057015

(51) Int. Cl. H01J 9/02; F21V 9/16

(52) U.S. Cl. 362/84; 313/310; 445/35

(57) ABSTRACT

An electron emission device includes a base substrate and first electrodes formed on the base substrate in one direction. Second electrodes are formed on the base substrate in the one direction and spaced apart from the first electrodes by a predetermined interval and parallel to each other. First electron emission layers are formed on the first electrodes. Second electron emission layers are formed on the second electrodes. The interval between adjacent first and second electrodes is substantially equal to an interval between adjacent first and second electron emission layers.

### CROSS-REFERENCE TO RELATED PATENT APPLICATIONS

This application claims priority to and the benefit of Korean Patent Application No. 10-2008-0057015, filed on Jun. 17, 2008, in the Korean Intellectual Property Office, the entire content of which is incorporated herein by reference.

### BACKGROUND OF THE INVENTION

1. Field of the Invention

The present invention relates to electron emission devices, and, more particularly, to an electron emission device that can be easily manufactured.

2. Description of the Related Art

Typical electron emission devices are classified into electron emission devices using a hot cathode as an electron emission source and electron emission devices using a cold cathode as an electron emission source. Examples of the electron emission device using the cold cathode as the electron emission source include a field emission device (FED) type electron emission device, a surface conduction emitter (SCE) type electron emission device, a metal insulator metal (MIM) type electron emission device, a metal insulator semiconductor (MIS) type electron emission device, and a ballistic electron surface emitting (BSE) type electron emission device.

FED type electron emission devices are based on the principle that when a material having a low work function or a high beta function is used as an electron emission source, electrons are easily emitted due to an electric field difference in a vacuum. Accordingly, devices, in which a tip structure having a sharp front end formed of molybdenum (Mo) or silicon (Si), a carbonaceous material such as graphite or diamond like carbon (DLC), or a nano material such as nanotubes or nano wires is used as an electron emission source, have been developed.

FIG. 1 is a cross-sectional view of a conventional electron emission type backlight unit 100 including an electron emission device 101.

Referring to FIG. 1, the conventional electron emission type backlight unit 100 includes the electron emission device 101 and a front panel 102. The front panel 102 includes a front substrate 90, an electrode 80 formed on a bottom surface of the front substrate 90, and a phosphor layer 70 coated on the electrode 80.

The electron emission device 101 includes a base substrate 10 facing the front substrate 90 and disposed in parallel to the front substrate 90, a stripe-shaped electrode 20 formed on the base substrate 10, a stripe-shaped electrode 30 disposed in parallel to the electrode 20, and electron emission layers 40, 50 respectively disposed around the electrode 20 and the electrode 30. An electron emission gap G is formed between the electrode emission layers 40, 50 that respectively surround the electrode 20 and the electrode 30.

A vacuum space 103 having a pressure lower than atmospheric pressure is formed between the front panel 102 and the electron emission device 101. Spacers 60 are disposed at predetermined intervals between the front panel 102 and the electron emission device 101 in order to support a pressure generated by a vacuum state between the front panel 102 and the electron emission device 101.

In the conventional electron emission type backlight unit 100 constructed as described above, electrons are emitted by the electron emission layers 40, 50 due to an electric field formed between the first electrode 20 and the second electrode 30. That is, electrons are emitted by the electron emission layer 40, 50 disposed around one of the first electrode 20 and the second electrode 30 which acts as a cathode. The emitted electrons migrate toward the electrode 80 acting as an anode, and then are accelerated toward the phosphor layer 70 due to a strong electric field of the electrode 80.

However, the conventional electron emission type backlight unit 100 has problems in that the process of manufacturing the electron emission layers 40, 50 is complicated. It is difficult to meet optimal conditions for forming the electron emission layers 40, 50, and the electron emission characteristics of the electron emission layers 40, 50 may be deteriorated during the manufacturing process. In other words, it is difficult to manufacture the electron emission layers 40, 50 by a conventional process, such as screen printing or spin coating, so that an interval between the electron emission layers 40, 50 is optimal for the operation of the electron emission device 101.

### SUMMARY OF THE INVENTION

In accordance with the present invention an electron emission device is provided that can be easily manufactured by allowing an interval between electron emission layers to be adjusted simply by adjusting an interval between electrodes. Also provided is an electron emission type backlight unit including the electron emission device, which can operate at a low driving voltage, and a method of simply manufacturing the electron emission device.

According to an exemplary embodiment of the present invention, there is provided an electron emission device having a base substrate. First electrodes are formed on the base substrate in one direction. Second electrodes are formed on the base substrate in the one direction and are spaced apart from the first electrodes by a predetermined interval and to be disposed in parallel to the first electrodes. First electron emission layers are formed on the first electrodes. Second electron emission layers are formed on the second electrodes. The interval between adjacent first and second electrodes is substantially equal to an interval between adjacent first and second electron emission layers.

The interval between the adjacent first electrodes and second electrodes may range from 1 to 30 μm.

The interval between the adjacent first electron emission layers and second electron emission layers may be adjusted by adjusting the interval between the first electrode and the second electrode.

Each of the first electron emission layers and the second electron emission layers may include at least one of a carbide-derived carbon and a carbon nanotube.

The first electrodes and the first electron emission layers may have substantially the same width.

The second electrodes and the second electron emission layers may have substantially the same width.

According to another aspect of the present invention, there is provided an electron emission type backlight unit having the electron emission device. A phosphor layer faces the electron emission layers of the electron emission device. Third electrodes accelerate electrons emitted by the electron emission device toward the phosphor layer.

According to yet another exemplary embodiment of the present invention, there is provided a method of manufacturing an electron emission device. First electrodes and second electrodes are formed at predetermined intervals in parallel to each other on a base substrate. First electron emission layers and second electron emission layers are formed respectively on the first electrodes and the second electrodes so that the first electron emission layers and the second electron emission layers are electrically connected to the first electrodes or the second electrodes and an interval between adjacent first and second electron emission layers is substantially equal to the interval between adjacent first and second electrodes.

The forming of the first electrodes and the second electrodes may include forming the first electrodes and the second electrodes so that the interval between adjacent first electrodes and second electrodes ranges from 1 to 30 μm.

The forming of the first electron emission layers and the second electron emission layers may include forming the first electron emission layers and the second electron emission layers so that the interval between adjacent first electron emission layers and second electron emission layers ranges from 1 to 30 μm and is equal to the interval between the first electrode and the second electrode.

The forming of the first electron emission layers and the second electron emission layers may include stacking an electron emission layer material to cover the base substrate, the first electrodes, and the second electrodes, and patterning the stacked electron emission layer material to form the electron emission layers respectively on the first electrodes and the second electrodes.

The forming of the first electron emission layers and the second electron emission layers may include performing back exposure.

The forming of the first electron emission layers and the second electron emission layers may include: performing an exposure process to cure portions of an electron emission layer material by using the first electrodes and the second electrodes as masks; and performing a development process to remove portions of the electron emission layer material other than the cured portions by using a developing solution.

### BRIEF DESCRIPTION OF THE DRAWINGS

FIG. 1 is a cross-sectional view of a conventional electron emission type backlight unit.

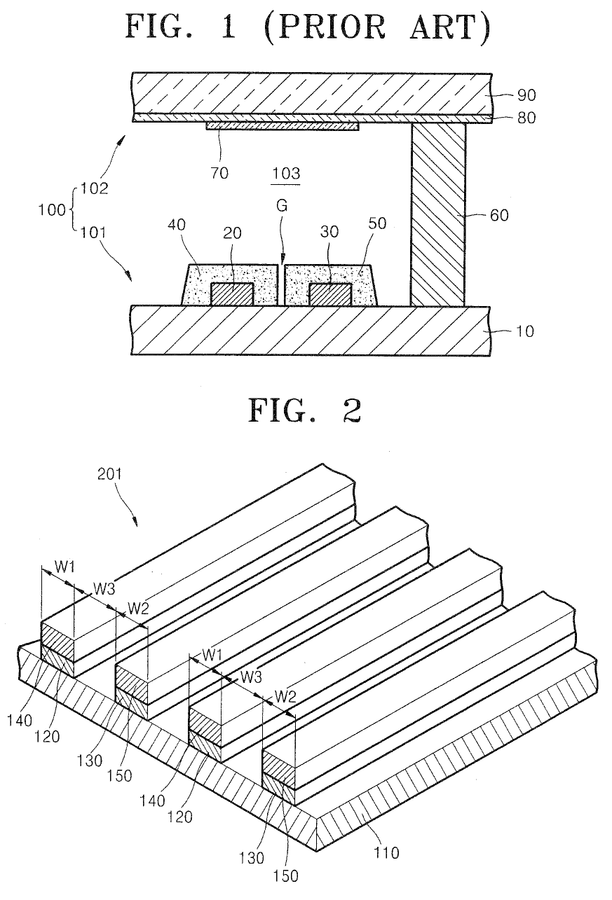

FIG. 2 is a partially cut-away perspective view of an electron emission device according to an exemplary embodiment of the present invention.

FIG. 3 is a graph illustrating a relationship between an electric field and current density.

FIG. 4 is a cross-sectional view of an electron emission type backlight unit including the electron emission device of FIG. 2, according to an exemplary embodiment of the present invention.

FIGS. 5A through 5E are cross-sectional views illustrating a method of manufacturing the electron emission device of FIG. 2, according to an exemplary embodiment of the present invention.

### DETAILED DESCRIPTION

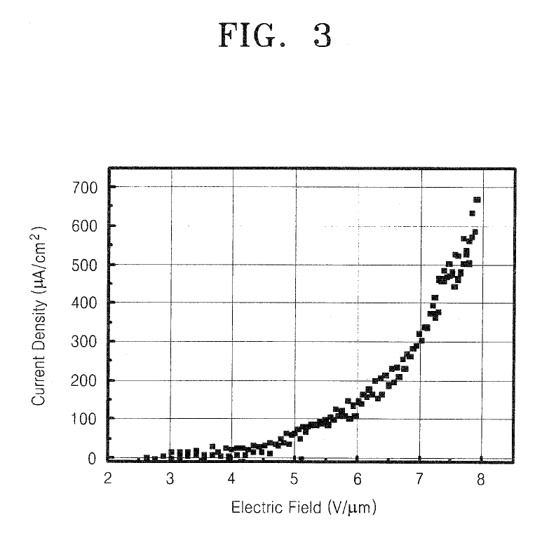

Referring to FIG. 2, the electron emission device 201 includes a base substrate 110, a plurality of first electrodes 120, a plurality of second electrodes 130, a plurality of first electron emission layers 140, and a plurality of second electron emission layers 150.

The base substrate 110, which is a plate-shaped member having a predetermined thickness, may be a quartz glass substrate, a glass substrate containing a small amount of impurity, such as Na, a plate glass substrate, a glass substrate coated with SiO₂, an aluminum oxide substrate, or a ceramic substrate. When the electron emission device 201 is used for a flexible display apparatus, the base substrate 110 may be formed of a flexible material.

The first electrodes 120 and the second electrodes 130 alternately extend on the base substrate 110 in one direction and are spaced apart from each other. Each of the first electrodes 120 and the second electrodes 130 may be formed of an electrically conductive material, for example, Al, Ti, Cr, Ni, Au, Ag, Mo, W, Pt, Cu, or Pd, or an alloy thereof; a printed conductor containing glass and metal, such as Pd, Ag, RuO₂, or Pd—Ag, or a metal oxide; a transparent conductor such as ITO, In₂O₃, or SnO₂; or a semiconductor material such as polysilicon.

An interval between adjacent first and second electrodes 120, 130 may range from about 1 to 30 μm. The interval between the first electrode 120 and the second electrode 130 will be explained below in more detail.

The first electron emission layers 140 are formed on the first electrodes 120, and the second electron emission layers 150 are formed on the second electrodes 130. The first electron emission layers 140 are electrically connected to the first electrodes 120, and the second electron emission layers 150 are electrically connected to the second electrodes 130.

Each of the first electron emission layers 140 and the second electron emission layers 150 may include a carbide-derived carbon as an electron emission material. The carbide-derived carbon may be prepared by a thermochemical reaction between a carbide compound and halogen group element containing gas to extract elements other than carbon included in the carbide compound.

The carbide compound may be at least one carbide compound selected from the group consisting of SiC₄, B₄C, TiC, ZrCₓ, Al₄C₃, CaC₂, TiₓTa_{y}C, MoₓW_{y}C, TiNₓC_{y}, and ZrNₓC_{y}. The halogen group element containing gas may be Cl₂, TiCl₄, or F₂. The electron emission layers 140, 150 containing the carbide-derived carbon have excellent electron emission uniformity and long lifetime. The carbide-derived carbon is different from carbon nanotubes (CNTs) in structure, but is similar to CNTs in field emission characteristics.

Each of the electron emission layers 140, 150 may include as an electron emission material CNTs having a low work function and a high beta function. Since CNTs have excellent electron emission characteristics and are easily driven with a low voltage, a display device using the CNTs as an electron emission source can be easily manufactured on a large scale. Alternatively, a carbonaceous material, such as graphite, diamond, or a diamond like carbon (DLC), or a nano material, such as nanotubes, nano wires, or nano rods, may be used as the electron emission material.

In FIG. 2, the electron emission layers 140, 150 are respectively formed on the first electrodes 120 and the second electrodes 130. In this case, since the first electrodes 120 and the second electrodes 130 can operate in turn, the lifetime of the electron emission device 201 can be increased by two times or more.

The electron emission device 201 may be formed so that an interval between adjacent first and second electrodes 120, 130 is substantially equal to an interval between adjacent first and second electron emission layers 140, 150. The interval may range from 1 to 30 μm.

A conventional electron emission device has problems in that a process of manufacturing electron emission layers is complicated. It is difficult to meet optimal conditions for forming the electron emission layers, and the electron emission characteristics of the electron emission layers may be deteriorated during the manufacturing process. In other words, it is difficult to manufacture the electron emission layers by a conventional process, such as screen printing and spin coating, so that an interval between the electron emission layers is optimal for the operation of the conventional electron emission device.

However, the electron emission device 201 of FIG. 2 can be easily manufactured by allowing an interval between adjacent first and second electron emission layers 140, 150 to be adjusted simply by adjusting an interval between adjacent first and second electrodes 120, 130.

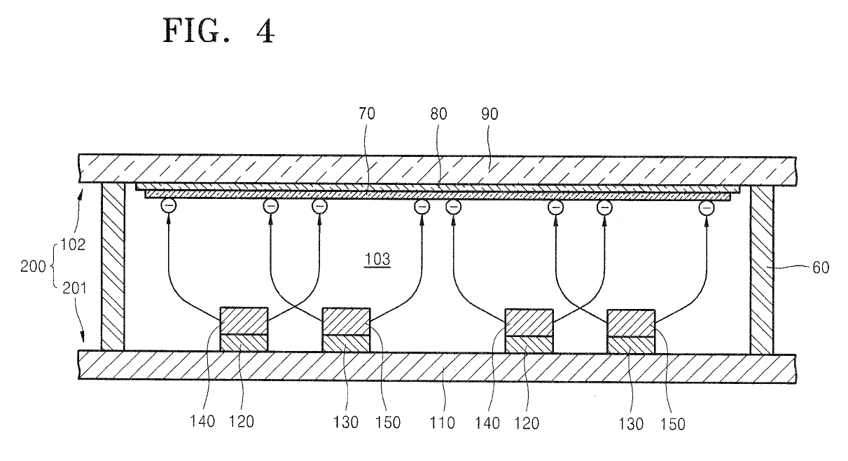

In FIG. 3, the horizontal axis represents an electric field (W/μm) applied between the first electrode 120 and the second electrode 130, and the vertical axis represents current density (μA/cm²) between the first electrode 120 and the second electrode 130.

Referring to FIG. 3, when an electric field is less than 4 V/μm, a maximum current density is almost close to 0. Accordingly, it can be found that the electron emission device 201 can operate only when an electric field is equal to or higher than 4 V/μm. Here, an electric field is the ratio of a driving voltage to an interval between the first electrode 120 and the second electrode 130. A driving integrated circuit (IC) of a backlight unit including an electron emission device typically uses 120 V. Accordingly, if a driving IC uses 120 V, in order to obtain an electric field of 4 V/μm or higher, an interval between the first electrode 120 and the second electrode 130 should range from 1 to 30 μm.

If a driving IC uses 250V and an interval between the first electrode 120 and the second electrode 130 is 30 μm, an electric field is approximately 8.3 V/μm, and thus a maximum current density is 700 to 800 μA/cm², thereby making it possible to drive the backlight unit. However, if such a high voltage is used, arcing may be caused due to the high voltage, power consumption may be increased, and the lifetime of the electron emission device 201 may be reduced. Accordingly, in an exemplary embodiment an interval between the first electrode 120 and the second electrode 130 is equal to or less than 30 μm. Also, considering current technological developments, it is not easy to reduce an interval between the first electrode 120 and the second electrode 130 to less than 1 μm, and even if possible, in an exemplary embodiment an interval between the first electrode 120 and the second electrode 130 is equal to or greater than 1 μm for economic reasons.

Referring back to FIG. 2, an interval W3 between the first electron emission layer 140 and the second electron emission layer 150 may be substantially equal to an interval W3 between the first electrode 120 and the second electrode 130. For example, when the interval W3 between the first electrode 120 and the second electrode 130 is 30 μm, the interval W3 between the first electron emission layer 140 and the second electron emission layer 150 may also be 30 μm.

In more detail, current metal patterning allows a nanoscale interval between electrodes. Accordingly, the first and second electrodes 120, 130 may be easily formed to have an interval ranging from 1 to 30 μm by metal patterning. However, it is not easy to form the first and second electrodes 120, 130 by using a conventional process such as screen printing or spin coating, so that they have an interval ranging from 1 to 30 μm.

Accordingly, the electron emission layers 140, 150 may be formed by preparing an electron emission layer material with a positive type photosensitive paste, forming the electron emission layer material on the first electrode 120 and the second electrode 130, and performing back exposure and development on the electron emission layer material to form the first and second electron emission layers 140, 150.

Since the electron emission layer material is formed on the first electrode 120 and the second electrode 130 and subjected to the back exposure to form the first and second electron emission layers 140, 150, the first electrode 120 and the first electron emission layer 140 have substantially the same width W1, and the second electrode 130 and the second electron emission layer 150 have substantially the same width W2, such that the interval W3 between the first and second electrodes 120, 130 is substantially equal to the interval W3 between the first and second electron emission layers 140, 150.

Accordingly, the electron emission device 201 of FIG. 2 can be manufactured to have an optimal interval between the first and second electrodes 120, 130 and an optimal interval between the first and second electron emission layers 140, 150 in this way. Furthermore, since the interval W3 between the first electron emission layer 140 and the second electron emission layer 150 can be adjusted simply by adjusting the interval W3 between the first electrode 120 and the second electrode 130, the manufacturing process can be significantly simplified. Moreover, since a separate process of forming a sacrificial layer is not necessary, surface contamination that may occur during a process of forming and removing the sacrificial layer may be avoided. In addition, since the first and second electrodes 120, 130 can be easily formed and a thin film process is omitted, investment costs in sputter equipment or the like can be reduced. Further, since the electron emission layer material is coated over entire surfaces of the first and second electrodes 120, 130, the number of contact points between the first and second electrodes 120, 130 and the electron emission layer material can be increased, thereby improving electron emission efficiency.

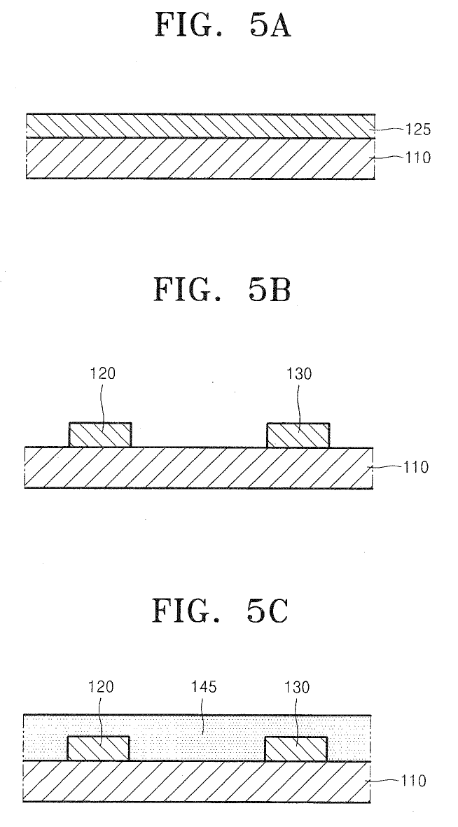

FIG. 4 is a cross-sectional view of an electron emission type backlight unit 200 including the electron emission device 201 of FIG. 2, according to an exemplary embodiment of the present invention.

Referring to FIG. 4, the electron emission type backlight unit 200 includes the electron emission device 201 of FIG. 2 and a front panel 102 facing the electron emission device 201.

The electron emission device 201 has already been explained in detail with reference to FIG. 2, and thus a further explanation thereof is not needed.

The front panel 102 includes a front substrate 90 through which visible light is transmitted, a phosphor layer 70 disposed on the front substrate 90 and excited by electrons emitted by the electron emission device 201 to generate visible light, and third electrodes 80 for accelerating the electrons emitted by the electron emission device 201 toward the phosphor layer 70.

The front substrate 90 may be formed of the same material as that of the base substrate 110 and may be transparent to visible light.

The third electrodes 80 may be formed of the same material as that of the first electrodes 120 or the second electrodes 130. Here, the third electrodes 80 may act as anodes.

The phosphor layer 70 is formed of a cathode luminescent (CL) type phosphor that is excited by accelerated electrons to generate visible light. Examples of the phosphor used to form the phosphor layer 70 may include a red phosphor including SrTiO₃:Pr, Y₂O₃:Eu, or Y₂O₃S:Eu, a green phosphor including Zn(Ga, Al)₂O₄:Mn, Y₃(Al, Ga)₅O₁₂:Tb, Y₂SiO₅:Tb, or ZnS:Cu,Al, and a blue phosphor including Y₂SiO₅:Ce, ZnGa₂O₄, or ZnS:Ag,Cl. However, the present invention is not limited to the above phosphors.

In order to normally operate the electron emission type backlight unit 200, a space between the phosphor layer 70 and the electron emission device 201 is maintained in a vacuum. To this end, spacers 60 for maintaining the vacuum space between the phosphor layer 70 and the electron emission device 201 and a glass frit (not shown) for sealing the vacuum space may be further used. The glass frit is disposed around the vacuum space to seal the vacuum space.

The operation of the electron emission type backlight unit 200 constructed as described above will now be explained. A negative (−) voltage is applied to the first electrodes 120 disposed on the electron emission device 201 and a positive (+) voltage is applied to the second electrodes 130 to form an electric field between the first electrodes 120 and the second electrodes 130, such that electrons are emitted by the first electron emission layers 140 toward the second electrodes 130 due to the electric field. When a positive (+) voltage that is much higher than the positive (+) voltage applied to the second electrodes 130 is applied to the third electrodes 80, the electrons emitted by the first electron emission layers 140 are accelerated toward the third electrodes 80. The electrons excite the phosphor layer 70 adjacent to the third electrodes 80 to generate visible light. The emission of the electrons may be controlled by the voltage applied to the second electrodes 130.

A negative (−) voltage is not necessarily applied to the first electrodes 120 as long as an appropriate electric potential necessary for electron emission is formed between the first electrodes 120 and the second electrodes 130.

Since the first electron emission layers 140 and the second electron emission layers 150 are formed opposite to each other, the electron emission type backlight unit 200 can be driven in a bipolar mode by alternately applying a negative (−) voltage and a positive (+) voltage to the first electrodes 120 and the second electrodes 130, thereby increasing the lifetime of the first and second electron emission layers 140, 150 and improving the brightness of the electron emission type backlight unit 200.

The electron emission type backlight unit 200 of FIG. 4 may be used as a surface light source for a non-emissive display device such as a thin film transistor-liquid crystal display (TFT-LCD). Further, in order to form an image or perform dimming as well as generating visible light as a surface light source, the electron emission type backlight unit 200 may be configured such that the first electrodes 120 and the second electrodes 130 may be alternately arranged. To this end, one of the first electrodes 120 and the second electrodes 130 may have main electrode parts and branch electrode parts, the main electrode parts may alternate with the remaining electrodes, the branch electrode parts may protrude from the main electrode parts to face the remaining electrodes, and the electron emission layers 140, 150 may be formed to face the branch electrode parts or the main electrode parts.

A method of manufacturing the electron emission device 201 of FIG. 2 will now be explained.

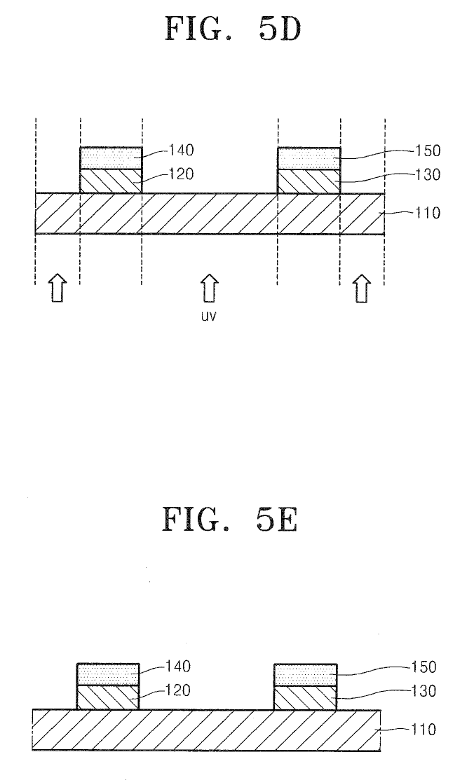

FIGS. 5A through 5E are cross-sectional views illustrating a method of manufacturing the electron emission device 201 of FIG. 2, according to an exemplary embodiment of the present invention.

Referring to FIG. 5A, an electrode material 125 is stacked on the base substrate 110. If the electrode material 125 is a metal, the electrode material 125 may be deposited on the base substrate 110.

Referring to FIG. 5B, the stacked electrode material 125 is patterned to form the first electrodes 120 and the second electrodes 130.

Referring to FIG. 5C, an electron emission layer material 145 is stacked to cover the base substrate 110 and the first and second electrodes 120, 130. The electron emission layer material 145 may be a positive type photosensitive paste.

Referring to FIG. 5D, the electron emission layer material 145 is patterned to form the first electron emission layers 140 and the second electron emission layers 150 respectively on the first electrodes 120 and the second electrodes 130.

Referring to FIG. 5E, the manufacture of the electron emission device 201 is completed.

The electron emission layer material 145 may be subjected to back exposure. In this case, since the first electrodes 120 and the second electrodes 130 serve as masks and thus a separate mask process is not necessary, the electron emission device 201 can be manufactured simply and manufacturing costs can be reduced. Moreover, since an interval between the first electron emission layers 140 and the second electron emission layers 150 can be adjusted simply by adjusting an interval between the first electrodes 120 and the second electrodes 130, the electron emission device 201 can be further simply manufactured. In addition, since a separate process of forming a sacrificial layer is not necessary, surface contamination that may occur during a process of forming and removing the sacrificial layer can be avoided.

As described above, the electron emission device, the electron emission type backlight unit including the same, and the method of manufacturing the electron emission device according to the present invention can simply and efficiently form the electron emission layer by allowing an interval between the electron emission layers to be adjusted simply by adjusting an interval between the electrodes. Furthermore, since the electron emission efficiency of the electron emission layers including the carbide-derived carbon is high, energy consumption can be reduced and the brightness of the electron emission device can be improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electron emission device comprising:
a base substrate;
first electrodes on the base substrate in one direction;
second electrodes on the base substrate in the one direction parallel to and spaced apart from the first electrodes;
first electron emission layers on the first electrodes; and
second electron emission layers on the second electrodes,
wherein an interval between adjacent first electrodes and second electrodes is substantially equal to an interval between adjacent first electron emission layers and second electron emission layers.

2. The electron emission device of claim 1, wherein the interval between adjacent first electrodes and the second electrodes ranges from 1 to 30 μm.

3. The electron emission device of claim 1, wherein the interval between adjacent first electron emission layers and second electron emission layers is adjustable by an adjustment of the interval between adjacent first electrodes and second electrodes.

4. The electron emission device of claim 1, wherein each of the first electron emission layers and the second electron emission layers comprise at least one of a carbide-derived carbon and a carbon nanotube.

5. The electron emission device of claim 1, wherein the first electrodes and the first electron emission layers have substantially the same width.

6. The electron emission device of claim 1, wherein the second electrodes and the second electron emission layers have substantially the same width.

7. An electron emission type backlight unit comprising:
an electron emission device comprising:
a base substrate;
first electrodes on the base substrate in one direction;
second electrodes on the base substrate in the one direction parallel to and spaced apart from the first electrodes;
first electron emission layers on the first electrodes; and
second electron emission layers on the second electrodes,
wherein an interval between adjacent first electrodes and second electrodes is substantially equal to an interval between adjacent first electron emission layers and second electron emission layers,
a phosphor layer facing the electron emission layers of the electron emission device; and
third electrodes for accelerating electrons emitted by the electron emission device toward the phosphor layer.

8. A method of manufacturing an electron emission device, the method comprising:
forming first electrodes and second electrodes spaced apart and parallel to each other on a base substrate; and
forming first electron emission layers and second electron emission layers respectively on and respectively electrically connected to the first electrodes and the second electrodes and having an interval between adjacent first electron emission layers and second electron emission layers being substantially equal to an interval between adjacent first electrodes and second electrodes.

9. The method of claim 8, wherein the forming of the first electrodes and the second electrodes comprises forming the first electrodes and the second electrodes such that the interval between adjacent first electrodes and second electrodes ranges from 1 to 30 μm.

10. The method of claim 9, wherein the forming of the first electron emission layers and the second electron emission layers comprises forming the first electron emission layers and the second electron emission layers such that the interval between adjacent first electron emission layers and second electron emission layer ranges from 1 to 30 μm and is equal to the interval between adjacent first electrodes and second electrodes.

11. The method of claim 8, wherein the forming of the first electron emission layers and the second electron emission layers comprises:
stacking an electron emission layer material to cover the base substrate, the first electrodes, and the second electrodes, and
patterning stacked electron emission layer material for forming the electron emission layers respectively on the first electrodes and the second electrodes.

12. The method of claim 8, wherein the forming of the first electron emission layers and the second electron emission layers comprises performing back exposure.

13. The method of claim 8, wherein the forming of the first electron emission layers and the second electron emission layers comprises:
performing an exposure process for curing portions of an electron emission layer material by using the first electrodes and the second electrodes as masks; and
performing a development process for removing portions of the electron emission layer material other than the cured portions by using a developing solution.
